(19) United States
(12) Patent Application Publication
(10) Pub. No.: US 2025/0068367 A1
(43) Pub. Date: Feb. 27, 2025

(54) DATA PROCESSING WHEREIN PUBLICITY IMAGE AND DATA IS DISPLAYED TO AN OPERATOR PRIOR TO APPROVAL FOR CREATION OF HARD COPY

(71) Applicant: Lee Goodwyn, JR., Richmond, VA (US)

(72) Inventor: Lee Goodwyn, JR., Richmond, VA (US)

(21) Appl. No.: 16/996,783

(22) Filed: Aug. 18, 2020

(51) Int. Cl. G06F 3/12; G06F 40/166

(52) U.S. Cl. CPC G06F 3/1238; G06F 3/1222; G06F 40/166

(57) ABSTRACT

The present invention includes a data processing system wherein age of data as interpreted by an output device is displayed for operator approval prior to output on a hard copy. The process and system for authorizing elements for physical surfaces as hard copies to be displayed at events, gatherings, sporting events, etc. Input script is transmitted to an operator authority party computer system with a visual element script substance. The operator authority party aids in compiling an approved final script. Authentication is aided in that a token is provided to indicate printing approval prior to output on a hard copy outside the control zone of the authority party, or the printing of a hard copy can occur inside a zone controlled by the authority party. Third parties can introduce script substance to a populated catalogue over a wide area network to users for commercial, controlled use.

### FIELD OF THE INVENTION

The present invention relates to the field of quality control and more specifically to the field of unified, authorized messaging.

### BACKGROUND

Large gatherings for dedicated purposes can draw a myriad of peoples and opinions. Gatherings for a dedicated purpose does not ensure that there is uniformity of messaging, or a measure of quality control. Gatherings can be infiltrated for purposes of “false flag” operations, or by opponents seeking to disparage the purpose, or people with fringe opinions that do not fit into the general consensus of the purpose. For protests or political gatherings, signage may misspell political persons, advocate violence, or otherwise cause disrepute to the gathering as a whole. For sporting events, fans may bring extreme opinions, disparaging language, or pornographic imagery. When an entity has the ability to control the zone of the gathering, or bounds, or entry; then there is an opportunity to provide quality control.

### SUMMARY

The present invention is directed to a publicity authentication system and process. The process of the present invention includes a series of steps that permit a user to create one or more banners that fit within the authorized messaging of an authority party. For the present disclosure, the parties can fit within two primary themes, the party that controls the messaging for an event and the party that desires to bring/utilize messaging at an event. An authority party faces a difficult conundrum at times; an authority party seeks to permit attendees at an event to express themselves, yet it is important that the expression not cross lines determined to be appropriate by the authority party.

The present invention includes transmitting an electronic data input script bearing natural language text from a user to an authority party computer system. The computer system includes an arithmetic logic unit (“ALU”) and persistent data storage. Within the persistent data storage is an authentication cull list having pre-approved natural language text script substance. The authority party compiles an approved final script based on a comparison of said input script to the authentication cull list. An approved final script is acceptable for placement upon a physical surface provided therefor. The physical surface is then distributed to the user within an authority party control zone.

The authority party control zone will depend on the event or occurrence utilized by the authority party. For example, a football team may have as its control zone a stadium, a practice field, a conference room, a locker room, authorized retail stores, etc. A football team seeks to allow signage at its games, in fact, some clever signage is a desirable camera-magnet; however, certain signage can cross lines of good taste and decorum. There are two controls that the present invention can place on the messaging; the first by means of editorial review of the input script (desired by a fan), and then on the monitoring of signage within the control zone (e.g., a stadium) of the authority party. In the embodiment of the present invention above, the control is maintained because the authority party monitors the message and the distributes the signage within the control zone. In other embodiments, the present invention relies on certification.

Another embodiment of the present invention, includes transmitting an electronic data input script bearing natural language text from a user to an authority party computer system. The computer system includes an ALU and persistent data storage. Within the persistent data storage is an authentication cull list having pre-approved natural language text script substance. The authority party compiles an approved final script based on a comparison of said input script to the authentication cull list. An approved final script is transmitted to the user for placement upon a physical surface exterior to the zone of control, but to ensure authenticity, an authority token is applied to the physical surface.

In the embodiment described above, the user is the origin of the input script—but s/he need not be. Artistry and messaging can come from many sources, and third parties can be an especially rich source of artistry and messaging. Early steps of the present invention include transmitting an electronic data input script bearing natural language text from a user to an authority party computer system, having an ALU and persistent data storage unit with an authentication cull list having pre-approved natural language text script substance. An approved final script is compiled based on a comparison of the input script to the authentication cull list. Once approved this final script, and other final scripts, are populated in a catalogue bearing said final scripts in an electronic file catalogue database. The final scripts of the file catalogue are displayed over a Wide Area Network to multiple users with an indication of approval by the authority party. A user, who need not be the same “user” who created the final script, can select one or more final scripts for use in relation to an authority party control zone.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2 is a view of a banner of the present invention.

FIG. 3 is a view of the system of the present invention.

FIG. 4 is a view of the system of the present invention.

FIG. 5 is a view of the system of the present invention.

FIG. 6 is a view of the system of the present invention.

FIG. 7 is a view of the system of the present invention.

FIG. 8 is a view of the system of the present invention.

FIG. 9 is a view of the system of the present invention.

### DETAILED DESCRIPTION

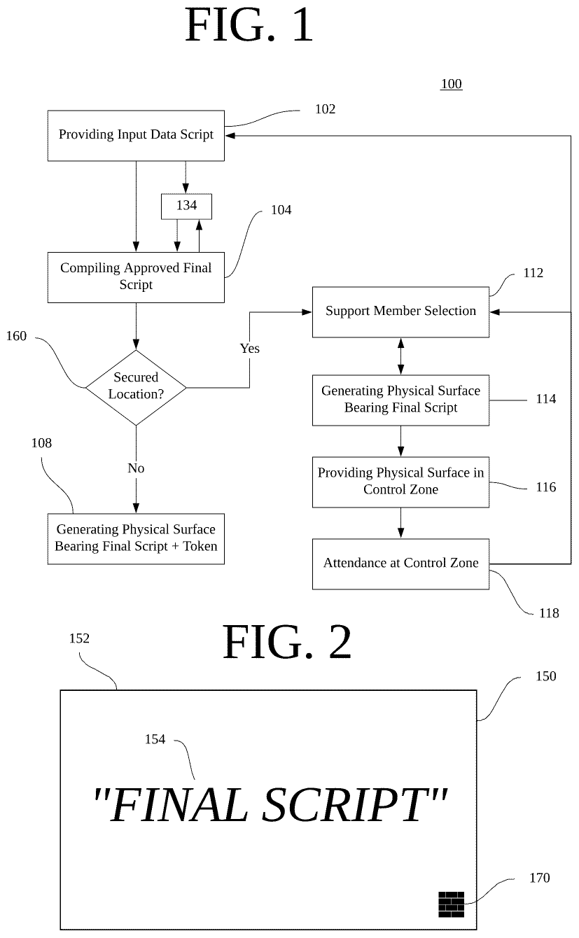

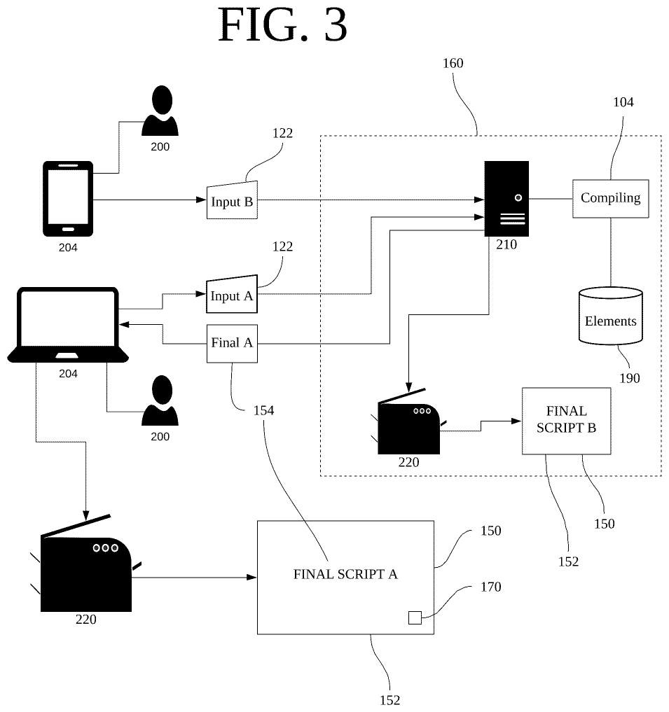

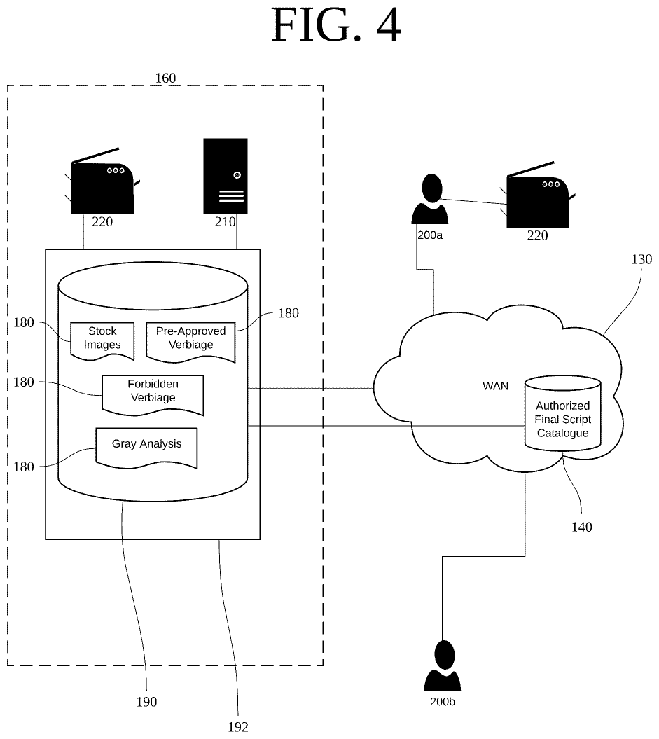

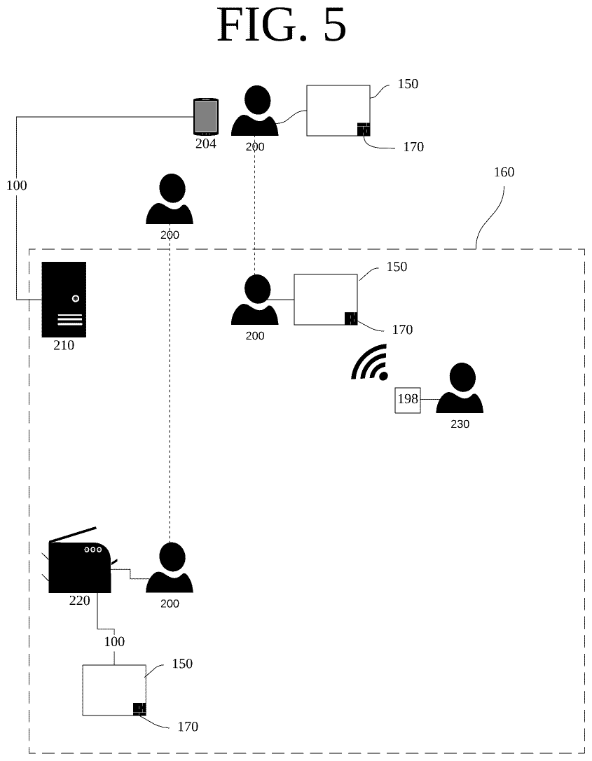

Referring first to FIGS. 1, 3-4, a basic embodiment of the process 100 is shown. The process of the present invention includes a series of steps that permit a user to create one or more banners that fit within the authorized messaging of an authority party. The present invention includes transmitting 102 an electronic data input script 122 bearing visual elements, such as natural language text, from a user 200 and a user computer 204 to an authority party computer system 210. The authority computer system 210 includes an arithmetic logic unit (“ALU”) and persistent data storage. By the step of providing 102 or transmitting, it is meant that data is passed from the user to the authority party using signal-based communication.

The input script 122 of the present invention can any form of communication, and is composed of script elements. An element for purposes of the present invention includes any portrayal of a visual component that can communicate a message. Elements can include: words, language, pictures, geometric shapes, colors, etc. Any of these elements can include beneficial or detrimental connotations to an authority party. For example, at a Redskins football game, certain shades of red or yellow may be approved, while others may be detrimental. The colors of the Redskins professional football team are garnet and gold, not simply red and yellow; and a television camera that pans an audience of signage creates a distracting scene where myriad shades of red and yellow are exhibited. When jerseys for a football team, for example, the Alabama Crimson Tide are created, the shade of color is carefully monitored and controlled-particularly when a color is associated with the team name. The RGB rates will be tightly-balanced because there is a beauty and aesthetic in uniformity. The tight controls that are applied to team-issued equipment, and team-sponsored apparel can now be applied to banners and other signage. In other examples, the message of signage is of greater significance than the portrayal, and although football stadiums may desire certain substantive messaging be banned, demonstrations may acquire the greatest benefit from such authentication.

For purposes of the present invention a banner is meant to include any physical surface visual portrayal of a visual element to another party. A banner can be mean signage, decor of a physical structure, wearable apparel with a visual display, or any way of portraying visual elements. Because the present invention can be applied to any physical surface, it is simplest to discuss the present invention in terms of a “banner.” Any banner associated with an authority party can be the subject of control of the present invention. Other examples of a banner include any physical medium that can accept visual display, including business cards, pamphlets, apparel, magazines, holograms, models, life-size cutouts, etc.

The user 200 can have a computer 204 and the authority party (not shown) can have a computer 210. Other electronic equipment utilized to implement the process of the present invention can be utilized, particularly a printer 220 to generate the banner 150 bearing the physical surface 152 of the present invention. By printer, it is meant any computer component that can accept a signal and transform the data into a physical interpretation, including where the physical surface is paper, or a three-dimensional structure. Any component that can generate the visual elements that are desirable or undesirable, can be utilized as a printer or generator of the present invention. Any software utilized to implement the present invention may be utilized, including word processing programs. Any program that create, arrange, modify, stylize, or otherwise render or transform a message may be utilized.

Within persistent data storage of the authority party computer 210 is an authentication cull list having pre-approved visual element script substance have cull elements 180. The user provided input script, and in that input script could be a myriad of visual elements, for example: “GO DUKE BLU DEVILS.” The visual elements could include (1) a font 180, (2) substance 180, (3) grammar180, (4) color180, (5) order and arrangement 180, (6) etc. Each of these constitutes a visual element capable of authorization. The cull list can include any whitelist element (i.e., approved elements) or blacklist element (i.e., forbidden elements) thought worthwhile to the authority party. Duke University can include a particular font whitelist of approved fonts, and a font list of forbidden fonts. If the input script includes a particular font, the authority party-presumable a Duke University or a party controlled by Duke University—can indicate approval or disapproval of the font. The substance of the input script “Go Duke Blue Devils” can be the subject of the cull list, the cliché of sports team that “goes” is well within the bounds of good taste and would likely pass and decorum or other control of an authority party. Substance that might find its place on a blacklist include curse words, cuss words, or use of insulting plays-on-words, for example. The grammar of “GO DUKE BLU DEVILS” has an existing problem, a misspelling; other grammatical elements such as ALLCAPS or the punctuation, e.g. an exclamation point, etc. may all be the subject of whitelist or blacklist. The color of the input script can be subjected to whitelist or blacklist, such that only particular shades of blue can be utilized. Baby blue might be forbidden as that shade, and similar shades are not only effeminate—but also tied to a local rival, North Carolina Tarheels. The order and arrangement of the visual elements can be the subject of whitelist and blacklist such that the authority party ensures that signs visual elements are readable, or perhaps occupy a suitable amount of positive space. All of these visual elements and others can be controlled by the authority figure. Other things to be controlled could be script that is to be audibly generated and/or consumed by person(s) at an event, for instance speeches to a crowd, spoken word poetry delivered to a poetry audience, a song delivered to a crowd, karaoke, etc.

There is a comparison of the input script to the cull list, a compilation 104, that results in an approved final script. The approved final script includes the visual elements that authority party accepts as suitable for a control zone. The final script can include the approved visual elements “as is” to the user, or the authority party can transmit 134 an intermediate script back to the user for approval. The intermediate script can include options for edits to be made available to the user, such that the user can select from different options for any of the visual elements, which can include any number of visual elements that are acceptable to the authority party. Furthermore, the intermediate script can seek explanation or further input from a user prior to final approval.

Furthermore, there can be a gray analysis 180 in addition to the black-white lists kept in the cull list. A gray analysis can occur when a visual element is neither on the blacklist nor the whitelist, and further investigation is warranted. Further investigation can include an artificial intelligence search for the propriety of a visual element, or a simple flag that results in the visual element being provided to a member of the authority party.

The significance of a secured location, or also known as a control zone 160, can be key to certain embodiments of the present invention. An authority party may be indifferent to uses of signs outside of zones of control 160; however, uses in a control zone may indicate to viewers that the message or other visual elements are ‘approved’ or ‘sponsored’ by the authority party. This can be true whether protestors are in a zone of control 160, fans are piled into a sports stadium, or political party supporters are waiving signs. For purposes of the present invention a zone of control includes boundaries at which the authority party can control admittance on a physical, legal, or other basis.

In one preferred embodiment of the present invention, the physical surface 152 on which input script 122 is applied to a banner 150 occur exterior to the zone of control 160. In practical circumstances, this can include a football fan created a sign for a football game attendance stating “Yay! Yellowjackets!” This is created as input script in as much detail as the system can support and transmitted 102 to the authority computers 210 from the user computer 204. The authority computer compiles 104 a final script based on a comparison of the input script to the cull list. That final script may result in edits, or the final script may be identical to the initial script; in either event the ‘compilation’ of the present invention will be considered as having-occurred irrespective of changes, proposed or made. Because in the present scenario and embodiment, the user/fan is external to the zone of control at the time of input script transmission, and at the time of final script transmission (to the user from the authority party), the user may create a banner 150 using a physical surface 152 of his own means. In many events, this may be paper-based, or letter-based (for heat-adhesion letters), etc. However, the in addition to the transmission of the final script, an authorization token 170 is transmitted to the user to place adjacent, preferably, to the portrayal of the visual elements that constitute the final script. In certain embodiments of the present invention, the token 170 is an indication readable by the authority party, or those in concert therewith, that indicate that the final script has undergone the process steps of the present invention. In other versions of the invention, the token may be incorporated into the final script itself-such that steganography is utilized to finalize the present invention. In certain preferred embodiments, one or more steganographic features can be embedded in each letter and/or item on the physical medium to ensure that unauthorize modifications have not occurred. Preferred embodiments of the token may further include elements related to permission, such as creator name, user name, dates of authorization period or scope (e.g., perhaps for a hockey season, a single basketball game, a section of the Democrat party), a replication of the message that should be on the physical medium, printing source, etc. v The token is an indication that message has been suitably controlled and is acceptable to the authority party to be displayed at an event within the control zone.

In other embodiments of the present invention, the present invention transmits 102 the input script 122 from any location for the final script 154 to be applied to a banner 150 within the control zone. For example, consider a sports team business model wherein uniformity and quality of signage is controlled to the extent that messaging ought to be comprised of controlled substance and even quality of banner material. The transmission 102 of the input script reaches the authority party computer 210 and undergoes the compilation subprocess 104. The user 200 can be provided 116 the banner bearing the final script 154 on the physical surface 152 within the event control zone 160. For example, American football games often have tightly controlled entryways such that any materials brought into a football game are scrutinized. Signage brought into the stadium from the outside may be required to bear the token described in the embodiment above, and/or unauthorized signage may be prohibited entirely at the entry points. This makes policing banners and signage considerably simpler; with trusted entry points, all signage present within the control zone is likely authorized signage.

The present invention permits for the authority party to include printers or other generators 114 of physical surfaces bearing the final scripts from the users such that the banners need only be ‘retrieved’ upon entry into the stadium. This additionally make transit to a game simpler. When an authority party can control the physical surfaces 152 upon which messaging is placed, uniformity quality can be at the highest levels, for example cardboard of a certain clarity and texture and rigidity. Furthermore, an entire banner experience may await a fan such as selecting 112 a support member for use with the signage. In further refinements of this experience the support members may be selected from support member stock that includes various support members of differing shapes, size, and configurations that permit different uses of signs. For example, a longer banners may includes three or more sticks that allow a row of users to hold the banner; handled support members allow a sign to be waived; elongate support members allow signs to be hoisted high at key moments. Along those lines, various support members for signage may interfere with the viewing experience of other fans such that support members that posses overly elongate orientations may be forbidden among the quality control attributes.

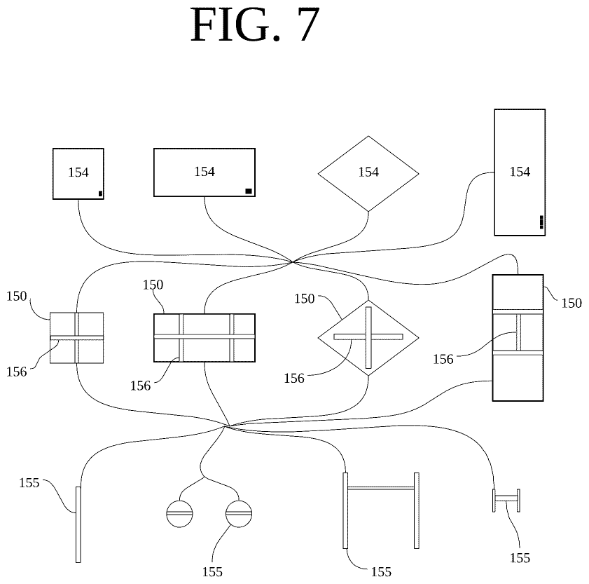

Turning to FIG. 7, a feature that is presently missing from sporting and other events is the replacement or refreshment of banners while in attendance in an authority party's control zone 118. It is a feature of the present invention that a banner support member may be universally attached to multiple signs, so that a support member can fit any number of banners. The banners may include a reinforced backing that supports many different banner types. A user of a banner may change the size, shape, or orientation (or other feature) of the banner during use may maintaining a single, approved message. Alternatively, the user may vary the message by providing new input script 102 or by adopting an intermediate script 134 previously approved by the authority party. In addition to a support member 155 that can apply to multiple banner types, it is a further feature of the present invention that the banner can apply to multiple support member 155 types. While attending 118 a function, a user can simply ‘swap out’ the support member 155 to an alternative type of support—or perhaps even the same support, but a newer version of the same. The bracing 156 on the rear of the banner 150 may have common elements that supports multiple versions of the support members.

Returning to FIGS. 1-4, the present invention may further utilize users 200 that are not end users 200a of the banners 150. For example, third party users, i.e. supplemental users 200b, may be utilized that design script elements for use in banners 150 for the end users 200a during attendance at authority party events. Here, the aspect of control either internal or external to zones of control is less significant, and the control by the authority party derives from its approval of the supplemental user 200b and their script elements. Here, the supplemental user 200b provides 102 input script elements that are provided to the authority party. The authority party treats the supplemental user 200b as any other user wherein the script elements are reviewed through the compilation substep 104. However, rather than necessarily providing permissions to the supplemental user 200b, the final script 154 and others like it are populated into a catalogue 140 of pre-authorized final scripts, or final script elements. Accordingly an end user can shop among a myriad of final scripts for signage for display at an event. As part of the compilation process 104 wherein the cull list compares desired input script to blacklist elements, for a premium the cull list can include final scripts marked for exclusivity.

The exclusivity can be based on any of the elements that can be examined during the cull process. For example, if a team wanted only a single user to appear with a “John 3:16” sign at an event, the cull list can white list the substance “John 3:16” for a single use, and upon compiling 104 by a single user (or designated quantity of users), and move the substance “John 3:16” to the black list such that any further attempt to acquire the substance would be negated by the system. Furthermore, materials made available to the Authorized Final Script Catalogue 140 could be added to the black list such that these third party materials, or the elements thereof, could be exclusives. The Authorized Final Script Catalogue can include any of the elements that could be a member 180 of the cull list. A preferred element 180 includes pictoral representations. Authors of unique content can be rewarded with third party contracts, so that authors of interesting content have an incentive to create and associate the content with a team, event, or cause. Another preferred element 180 includes verbiage, such as “Kentucky Mildcats!” The first person to suggest such a play-on-words can be rewarded with exclusivity, contracts, etc. Stock images could be a preferred element 180 so that there is only one portrayal of content types. Not only can the stock images be available, but be made available for replacement of poor likenesses of the officially-sanctioned images. Furthermore, there can be many likenesses of a mascot, some bad, some well-done, and perhaps more significantly the illustration can appear as prohibited illustrations. For example, if only one representation of a tiger is authorized by Louisiana State University, the team can ensure that only that type of tiger portrayal is utilized. Furthermore, if LSU is playing another school having a tiger mascot, such as Auburn or Missouri (both in the same conference!), then the Auburn and Missouri tiger official portrayals could be blacklisted. Colors could be utilized as preferred or third party elements, although colors tend to be tightly controlled by organizations. Accordingly, an authority party 200b can unleash the talents of the surrounding community in aid of events.

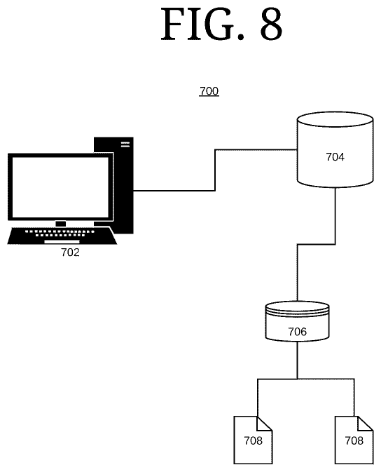

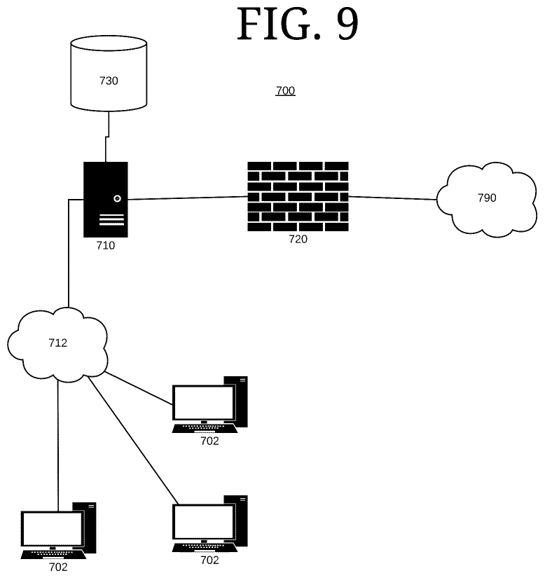

FIGS. 8-9 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent. It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets). The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

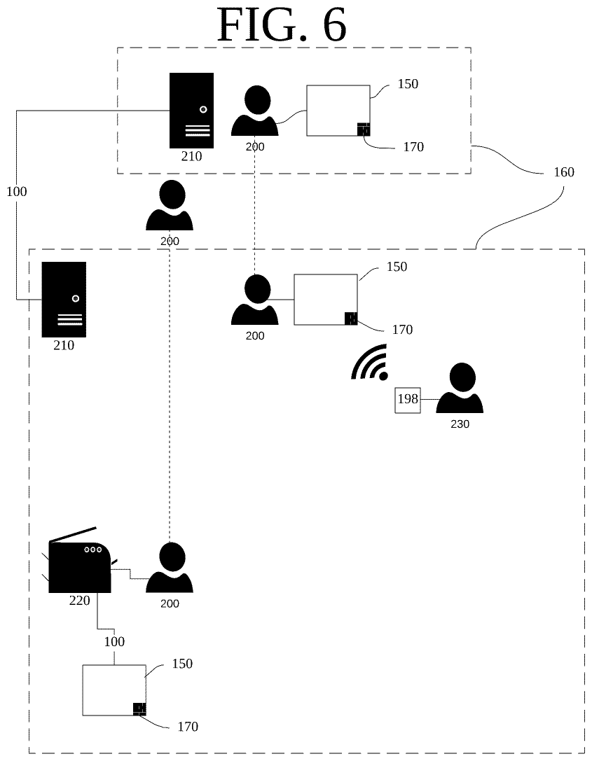

Returning to FIG. 6, the present invention can include authority control zones 160 that can be separated. An example of separate control zones 160 for an entity can include a sports franchise that controls the perimeter for a stadium, but also maintains leases on stores that sell equipment, jerseys, memorabilia, etc, and can provide banners 150 pursuant to the present invention. Here, the control zones 160 may include the tokens 170 because the banners, although printed 116 in a control zone 160 may leave the control zone 160 to head to another control zone 160 (e.g., from a sports store to a sports stadium). While at an event in one or more of the control zones 160, an authority party can utilize an authentication party 230 with a scanner 198, or other reading device, that can process information of the token 170 to determine authentication.

The token 170 of the present invention can include any means of storing information for later signal processing. A preferred version of token 170 can include an OCR code or a bar code that includes information on the sufficiency of the final script 154 appearing on the physical surface 152. Examples of information on the token can include a re-print of the final script to ensure that the approved final script is identical the final script as it appears on the banner. Other information on the token can include dates of validity, for example a discrete time period of use or a time period linked to a season, game, protest time period, concert, etc. Other tokens can include RFID chips, passive or active, that include any information pertinent to use of the process or system of the present invention.

In the invention a may to create a personal profile. This profile can contain such things as personal information, likes, interest, and other information. The profile can be linked and tied to the token. The invention can allow for a user to use his/her smartphone or other device to scan another users token automatically connect each other's profiles. This would encourage networking and community building around authority zones and/or causes. Two persons could be sitting next to each other at a game, network with each other, then scan each other tokens to connect to each other as if they were to exchange information manually.

Additionally, to encourage user banner participation and messaging unity among participants around the authority zone, the invention can have within it a program or feature where the authority party (but not limited to) can select any desired number of tokens and issue gifts, rewards, etc. to them. This could be a lottery or rewards type system where selected token holders can be sent rewards, etc. For instance, after a baseball game the authority party can randomly select one token number, ID, etc. that was tied to a physical surface and tell that person he/she can come down the to field after the game to meet the pitcher, or she could be electronically sent tickets to the next game to his/her inbox connected to her personal profile within the invention. With this invention a physical surface could also include user oriented/support/carried digital and/or electronic messaging, so long as the final message appears on a physical surface. Final script can be approve to be electronically sent to a user's smartphone for display, something like a handheld LED display board, or the like.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A publicity authentication process comprising:
transmitting an electronic data input script bearing visual elements from a user to an authority party computer system, having an arithmetic logic unit (“ALU”) and persistent data storage unit with an authentication cull list having pre-approved visual element script substance;
compiling an approved final script based on a comparison of said input script to said authentication cull list;
providing a physical surface bearing said final script; and
distributing said physical surface to said user within an authority party control zone.

2. The process of claim 1 wherein said party control zone is mobile.

3. The process of claim 1 wherein said generating step includes generating a message surface with a support member.

4. The process of claim 3 wherein said generating step includes generating a message surface with a releasably-affixable support member.

5. The process of claim 4 further comprising replacing said physical surface with a replacement physical surface to said releasably-affixable support member within said authority party control zone.

6. The process of claim 3 wherein said generating step includes selecting said support member from a support member stock.

7. The process of claim 6 further comprising replacing said support member with a replacement support member to said physical surface within said authority party control zone.

8. A publicity authentication process comprising:
transmitting an electronic data input script bearing visual elements from a user to an authority party computer system, having an arithmetic logic unit (“ALU”) and persistent data storage unit with an authentication cull list having pre-approved visual element script substance;
compiling an approved final script based on a comparison of said input script to said authentication cull list;
generating a physical surface, external to an authority party control zone, bearing said final script with an authority token applied to said physical surface.

9. The process of claim 8 further comprising the step of providing a token reader to a roving party, said token reader adapted to interpret said authority token.

10. The process of claim 8 further comprising the step of providing said token adjacent to said final script on said physical surface.

11. The process of claim 8 further comprising communicating from said authority party to said user at least two proposed modifications of natural language to said data input script.

12. The process of claim 11 wherein said authentication cull list includes prior approved final scripts for blacklist action.

14. The process of claim 12 further comprising wherein said providing step includes exclusively providing said physical surface to one said user.

15. A publicity authentication system comprising:
transmitting an electronic data input script bearing visual elements from a user to an authority party computer system, having an arithmetic logic unit (“ALU”) and persistent data storage unit with an authentication cull list having pre-approved visual element script substance;
compiling an approved final script based on a comparison of said input script to said authentication cull list;
populating a catalogue bearing said final script in an electronic file catalogue database;
displaying said catalogue over a Wide Area Network to multiple users with an indication of approval by said authority party;
providing a physical surface bearing said final script; and
distributing said physical surface to at least one of said multiple users for use in relation to an authority party control zone.

16. The process of claim 15 wherein said authentication cull list includes prior approved final scripts for blacklist action.

17. The process of claim 16 further comprising wherein said providing step includes exclusively providing said physical surface to one of said multiple users.

18. The process of claim 15 wherein said authorized party control zone is mobile.
